(19) United States
(12) Patent Application Publication
(10) Pub. No.: US 2016/0284496 A1
(43) Pub. Date: Sep. 29, 2016

(54) CURRENT SENSING SWITCH FOR USE WITH PUMPS

(71) Applicant: Reza Afshar, Westlake Village, CA (US)

(72) Inventor: Reza Afshar, Westlake Village, CA (US)

(21) Appl. No.: 14/667,690

(22) Filed: Mar. 25, 2015

(51) Int. Cl. H01H 47/22

(52) U.S. Cl. CPC H01H 47/22

(57) ABSTRACT

A current sensing switch for use with a pump that is physically separate from the pump and contains a current sensor for measuring the electrical current flowing to the pump as a method of determining whether the pump is operating in low fluid or dry conditions. When the current drops below a predetermined value for a predetermined amount of time, the switch electrically disconnects power to the pump.

### BACKGROUND OF INVENTION

1. Field of Invention

The present invention concerns a switch for use with a pump that prevents the pump from operating in low fluid or dry conditions.

2. Description of Prior Art

Pumps are the item of choice to remove fluid out from places such as flooded basements, window wells, and swimming pool covers. Pumps are also used in areas where fluid needs to be recirculated. Pumps are typically activated by the push of an electrical switch that is turned on when the pump is submerged in the fluid that needs to be removed or circulated. The pump then sucks the fluid in through a fluid inlet and pushes the fluid out through a fluid outlet to which a hose or pipe is attached that directs the fluid to the desired location.

A problem occurs if the pump is left activated in a condition in which fluid is not present. For example, a pump can be used to pump out fluid in a flooded basement. But once the fluid in the basement has been pumped out, the user often neglects to turn off the pump for an extended period of time. In essence, activating a pump while not submersed in fluid can lead to substantial overheating and damage to the pump motor. To resolve this problem, some pumps include a motor that is sealed in oil with an automatic thermal overload protector device. Thus, when he pump is left activated and not submerged in fluid, the motor begins to overheat and the thermal overload protector device is triggered to deactivate the pump automatically.

Other pumps utilize a pressure switch to measure the fluid pressure around the pump. When the pressure switch does not detect an fluid pressure, it deactivates the pump under the presumption that the pump is not submerged in fluid. Furthermore, as taught by U.S. Pat. No. 4,276,454, coated fluid repellant probes have been used to detect whether the pump is submerged in fluid. U.S. Pat. No. 4,881,873 teaches the use of an ultrasonic field detection system. U.S. Pat. No. 4.897,822, teaches the use of acoustic transducers. U.S. Pat. No. 5,425,624, teaches the use of optical fibers. Thus, a wide range of technologies have been used to address this problem of making sure a pump is not left activated while it is not submerged in fluid or in dry conditions.

Yet other pumps used a control circuit for turning off the power to the pump drive motor when the average current draw from the pump motor decreases below a preset level. This method of measuring the current has proven effective because the current through the pump motor is proportional to the work being done by the pump. Thus, measuring, the current can allow a system determine whether the pump is actually pumping fluid or just spinning in air. This concept of measuring the current is taught by U.S. Pat. No. 3,953,777; U.S. Patent Application No. 2013/0140912; and European Patent Application No. EP 2 439 413.

The problem with these devices is that they are electrically and/or physically connected to a pump and cannot be deactivated or adjusted to accommodate varying conditions. Furthermore, current sensing circuitry is typically built into a specific pump for ease of manufacturing. However, when the circuitry fails, the entire pump becomes unusable.

To address the deficiencies of the inventions mentioned above, what is needed is a device that can not only be electrically disconnected from a pump but can measure the current flow to the pump motor so that it deactivates the pump when the current falls below a predetermined level. Furthermore, a device is needed that can be used with pumps of varying sizes and power. Even further, a device is needed with a current sensing circuitry that can disconnect or deactivate a pump completely so as to prevent the pump from running in low fluid or dry conditions.

### SUMMARY OF THE INVENTION

Accordingly, the present invention has been made in view of the above-mentioned disadvantages occurring in the prior art. The present invention is a pump switch with a current sensing circuitry that prevent a pump from operating in low fluid or dry conditions.

It is therefore a primary object of the present invention to measure the current being fed into the pump as a way to measure the work being done by the pump.

Another object of the present invention is to provide a pump switch that is not built-in or incorporated in a pump.

Yet another object of the present invention to provide a pump switch that can detect false readings.

The above objects and other features and advantages of the present invention, as well as the structure and operation of various embodiments of the present invention, are described in detail below with reference to the accompanying drawings.

### DESCRIPTION OF THE DRAWINGS

The accompanying drawings which are incorporated by reference herein and form part of the specification, illustrate various embodiments of the present mention and, together with the description, further serve to explain the principles of the invention and to enable a person skilled in the pertinent art to make and use the invention. In the drawings, like reference numbers indicate identical or functional similar elements. A more complete appreciation of the invention and many of the attendant advantages thereof will be readily obtained as the same becomes better understood by reference to the following detailed description when considered in connection with the accompanying drawings, wherein:

FIG. 1 is a front perspective view of the pump switch of the present invention.

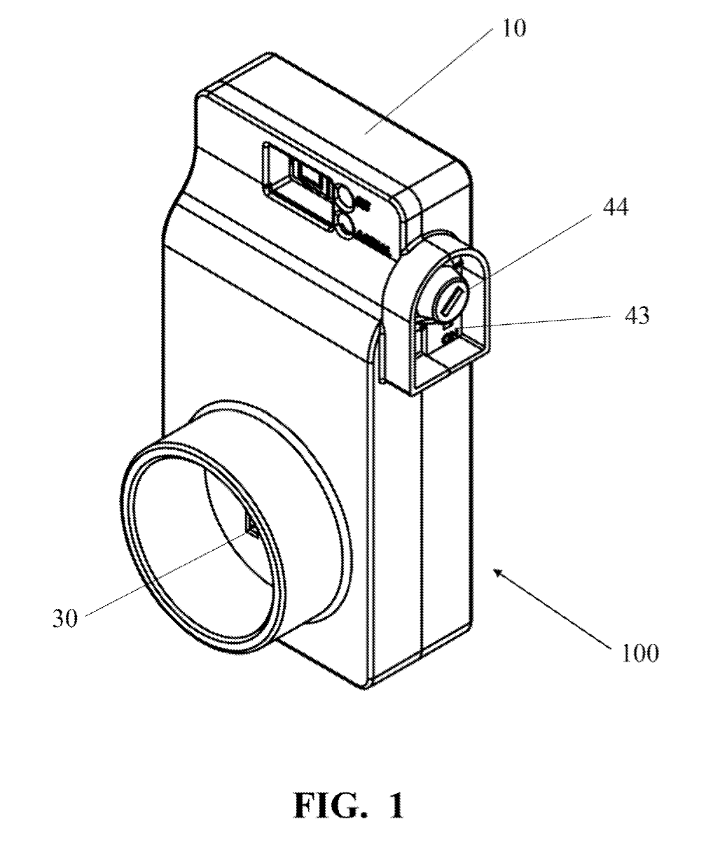

FIG. 2 is a front view of the pump switch of the present invention.

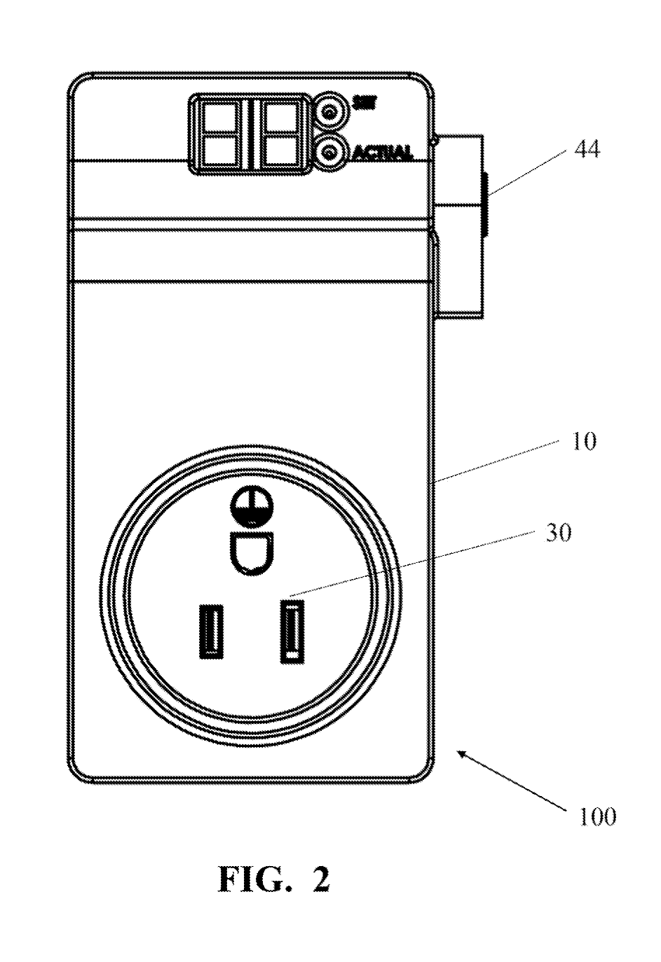

FIG. 3 is a side view of the pump switch of the present invention.

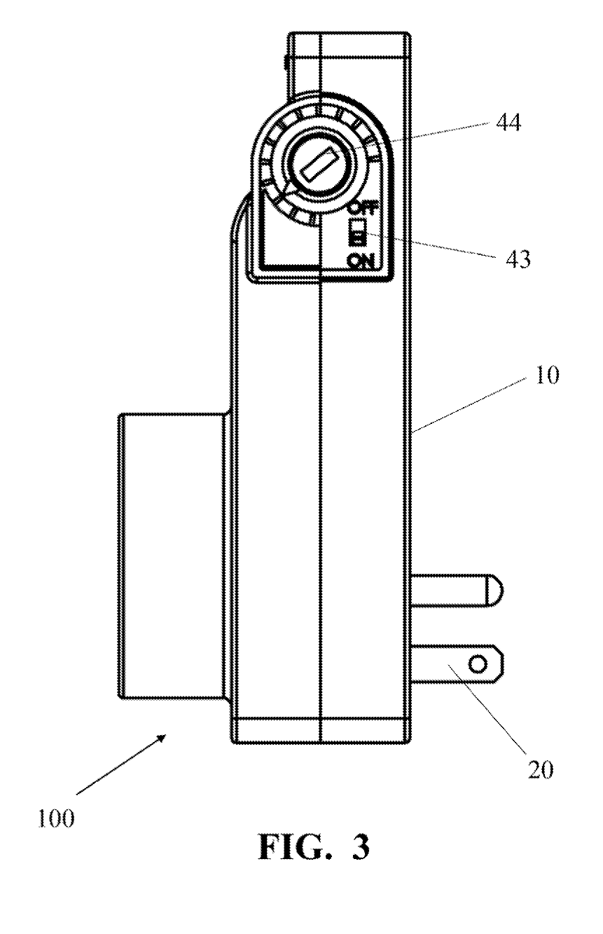

FIG. 4 is an exploded view of the pump switch of the present invention.

FIG. 5 is a diagram depicting the pump switch of the present invention connected to a pump.

### DETAILED DESCRIPTION OF THE PREFERRED EMBODIMENTS

Reference will now be made to the drawings in which various elements of the present invention will be given numerical designations and in which the invention will be discussed so as to enable one skilled in the art and make use the invention.

The present invention comprises a pump switch 100 with a housing 10 having prongs 20 of an electrical plug extending therefrom and an electrical plug socket 30. Inside the housing 10 is a circuit board 40 having a relay that is capable of electrically connecting and disconnecting the electrical plug socket 30 to the prongs 20 of the electrical plug. The circuit board 40 comprises a current sensor, a data center, a programmable controller, a power switch 43, and a current setting switch 44.

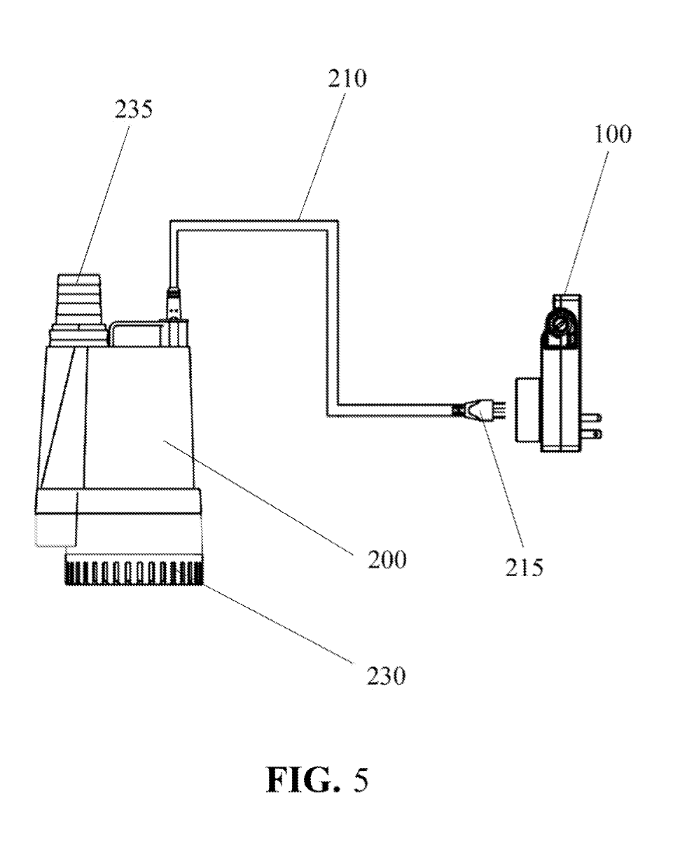

Application of the present invention is with pumps 200. As shown in FIG. 5, a pump 200 has an electrical cord 210 extending therefrom with an electrical plug 215 at the end. The electrical plug 215 is generally plugged in to an electrical plug socket through which electrical current is passed to power up and activate the pump 200. When the pump 200 is activated, a pump motor activates to drive an impeller. When the pump 200 is submerged in fluid, for example, the rotation of the impeller causes the fluid to flow such that the fluid is sucked in through the inlet 230 and pushed out of the outlet 235 of the pump 200.

However, a problem arises when the pump 200 is not submerged in fluid. This can occur when the pump 200 has finished pumping out or displacing all the fluid in which it was submerged. When the pump 200 operates and is not submerged in fluid, the impeller and the pump motor overheat and can be permanently damaged.

The present invention addresses this problem by electrically connecting the circuit board 40 in-line with the electrical plug socket, thus, the power source. Therefore, rather than connecting the electrical plug 215 directly to the electrical plug socket, the plug 215 is connected to the electrical plug socket 30 in the pump switch 100 of the present invention. The prongs 20 of the electrical plug in the pump switch 100 of the present invention is then connected to the electrical plug socket to which the plug 215 would normally be connected.

The current sensor 41 of the circuit board 40 measures the electrical current passing from the pump switch 100 of the present invention to the pump 200 through the plug 215. This is measured because the current passing to the pump 200 is proportional to the work being done by the pump 200. Thus, measuring the current can allow the pump switch 100 determine whether the pump is actually pumping fluid or just spinning in air.

The current setting switch 44 is used to set the electrical current limit for the pump switch 100. Thus, if the current passing to the pump 200, as measured by the current sensor 41, falls below the electrical current limit, then the pump switch 100 terminates the current flow to the pump 200 by electrically disconnecting the pump 200 from the power source.

When the user sets the current setting switch 44 to a particular setting, the digital value of said current setting is transmitted and stored within the data center in the circuit board 40. Then when the power switch 43 is turned to the “on” position, the pump 200 is activated and the current sensor 41 begins to measure the electrical current passing to the pump 200. The digital value of the electrical current passing to the pump 200 is periodically transmitted to the data center and is then compared with the current setting value. If the electrical current is less than the current setting value, then the pump switch 100 disconnects the pump 200 from the power source, thus, terminating the flow of current to the pump 200.

However, to avoid false readings, the pump switch 100 of the present invention incorporates a delay of a few predetermined seconds. Thus, when the electrical current drops below the current setting value, the pump switch 100 waits for the few predetermined seconds before disconnecting the pump 200 from the power source. If the electrical current is below the current setting for the duration of the few predetermined seconds, then the pump switch 100 disconnects the pump 200 from the power source. This delay allows the pump switch 100 to distinguish between a change in the electrical current caused by actual work done by the pump 200 or a change caused by other circumstances. Once the pump 200 is disconnected by the pump switch 100, the pump 200 has to be manually reset or restarted by the user to reconnect it to the power source. The connecting and disconnecting of the pump 200 from the power source is accomplished by the relay by electrically connecting or disconnecting the electrical plug socket to the prongs.

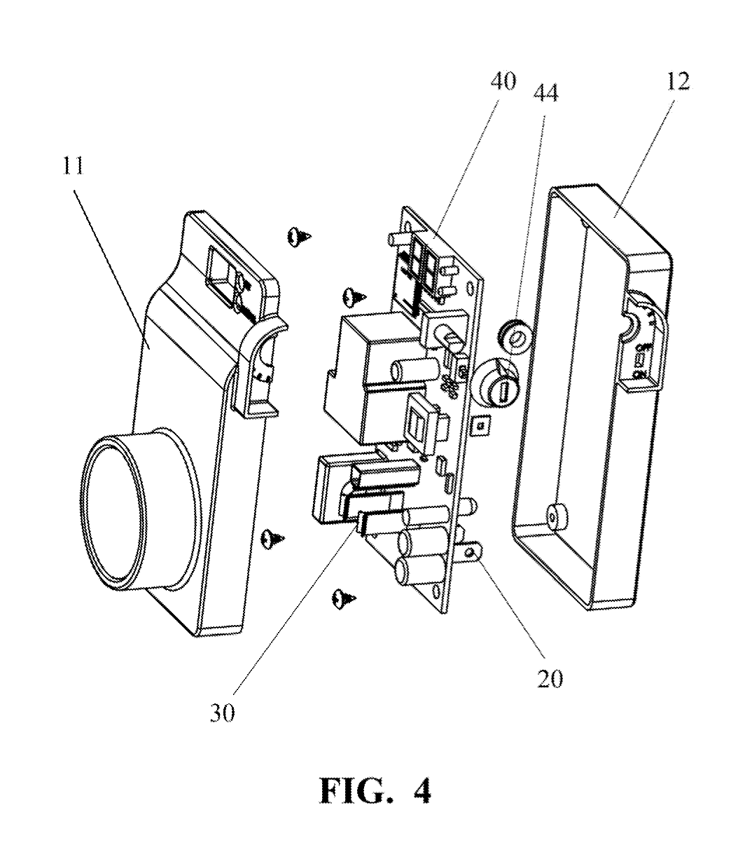

The housing 10 of the pump switch 100 comprises a first half 11 and a second half 12 that attach together with the circuit board 40 in between, as shown in FIG. 4. The housing 10 would provide weatherproofing of the pump switch 100 by the manner in which it encloses the circuit board 40 therewithin. The housing 10 would incorporate an o-ring or gasket in between said first half 11 and said second half 12 to protect the circuit board 40 from fluid exposure. Furthermore, a radial seal 13 would be used in the current setting switch 44 to further protect the circuit board 40 from fluid exposure. Finally, the power switch 43 would be encapsulated within a flexible thermoplastic protector to even further protect the circuit hoard 40 from fluid exposure.

It is understood that the described embodiments of the present invention are illustrative only, and that modifications thereof may occur to those skilled in the art. Accordingly, this invention is not to be regarded as limited to the embodiments disclosed, but to be limited only as defined by the appended claims herein.

What is claimed:

1. A switch for a pump comprising:
a housing having a plurality of prongs extending therefrom and a plug. socket;
a circuit board having a relay capable of electrically connecting and disconnecting said prongs to said plug socket;
said circuit board further comprising a programmable controller, a current sensor, a data center, a power switch, and a current setting switch;
wherein activating said power switch energizes said circuit board and causes said relay to electrically connect said prongs to said plug socket;
wherein said current sensor transmits to said data center a measurement of an electric current flowing to said pump through said plug socket;
wherein said current setting switch transmits to said data center a current setting value; and
wherein said controller compares said measurement from said current sensor to said current setting value such that if said measurement is less than said current setting value for a predetermined amount of time, then said controller causes said relay to electrically disconnect said prongs from said plug socket.

2. The switch for a pump according to claim 1 wherein said housing further comprises a first half and a second half that attach together to enclose said circuit board within a waterproofed cavity.

3. The switch for a pump according to claim 1 further comprising a microprocessor within which said data center and said programmable controller are incorporated.

4. The switch for a pump according to claim 1 further comprising a digital display that displays said measurement from said current sensor.

5. The switch for a pump according to claim 1 further comprising a digital display that displays said current setting value.
